(19) United States
(12) Patent Application Publication
(10) Pub. No.: US 2021/0047872 A1
(43) Pub. Date: Feb. 18, 2021

(54) HOLD OPEN HINGE

(71) Applicant: GM Global Technology Operations LLC, Detroit, MI (US)

(72) Inventors: Jairo Abraham Cruz Lopez, Cuautitlan Izcalli (MX); Cesar Daniel Madrid Ramirez, Toluca (MX)

(21) Appl. No.: 16/542,901

(22) Filed: Aug. 16, 2019

(51) Int. Cl. E05D 11/10; B60N 3/00; E05D 3/02

(52) U.S. Cl. CPC E05D 11/1014; B60N 3/00; E05Y 2201/218; E05Y 2900/538; E05D 3/02

(57) ABSTRACT

A hinge for a compartment in a motor vehicle includes a first plate having a portion that deflects when a force is applied to the portion, and a second plate pivotally attached to the first plate, the second plate having an extension that selectively engages with the portion of the first plate. The second plate has a first position when the extension of the second plate is not engaged with the portion of the first plate and has a second position when the extension of the second plate is engaged with the portion of the first plate.

### INTRODUCTION

The present disclosure relates to hinge for a compartment. More specifically, the present disclosure relates to a hold open hinge for a compartment in a motor vehicle.

Many motor vehicles include interior storage compartments, and some motor vehicles, such as, for example, pickup trucks include storage compartment that reside in the bed of the truck. Typically, the storage compartment includes a component that defines a storage area and a lid that covers the storage area for privacy and security. In some storage compartments, the lid is attached to the storage area component with one or more hinges that facilitate lifting the lid to provide access to the storage area. The occupant or user of the motor vehicle, however, typically has to hold the lid in the open position to prevent the lid from inadvertently closing over the storage area.

Thus, while current hinges for storage compartments achieve their intended purpose, there is a need for a new and improved hinge.

### SUMMARY

According to several aspects, a hinge for a compartment in a motor vehicle includes a first plate having a portion that deflects when a force is applied to the portion, and a second plate pivotally attached to the first plate, the second plate having an extension that selectively engages with the portion of the first plate. The second plate has a first position when the extension of the second plate is not engaged with the portion of the first plate and has a second position when the extension of the second plate is engaged with the portion of the first plate.

In an additional aspect of the present disclosure, the first plate is attached to a first component of the compartment, the first component defining storage area.

In another aspect of the present disclosure, the second plate is attached to a second component of the compartment, the second component being a lid.

In another aspect of the present disclosure, when the second plate is in the first position, the lid covers the storage area.

In another aspect of the present disclosure, when the second plate is in the second position, the lid is held open by the engagement of the extension of the second plate with the portion of the first plate to provide access to the storage area.

In another aspect of the present disclosure, the first plate and the second plate are made of a metal.

In another aspect of the present disclosure, the first plate and the second plate are made of a plastic.

In another aspect of the present disclosure, the first plate and the second plate are made of a composite material.

In another aspect of the present disclosure, the compartment is a storage compartment located in a bed of a truck.

In another aspect of the present disclosure, the compartment is located in a cabin of the motor vehicle.

According to several aspects, a hinge for a compartment in a motor vehicle includes a first plate having a portion that deflects when a force is applied to the portion, the first plate being attached to a first component of the compartment, the first component defining storage area, and a second plate pivotally attached to the first plate, the second plate having an extension that selectively engages with the portion of the first plate, the second plate being attached to a second component of the compartment, the second component being a lid. The second plate has a first position when the extension of the second plate is not engaged with the portion of the first plate, and wherein the second plate has a second position when the extension of the second plate is engaged with the portion of the first plate.

In another aspect of the present disclosure, when the second plate is in the first position, the lid covers the storage area.

In another aspect of the present disclosure, when the second plate is in the second position, the lid is held open by the engagement of the extension of the second plate with the portion of the first plate to provide access to the storage area.

In another aspect of the present disclosure, the first plate and the second plate are made of a metal.

In another aspect of the present disclosure, the first plate and the second plate are made of a plastic.

In another aspect of the present disclosure, the first plate and the second plate are made of a composite material.

According to several aspects, a storage compartment for a motor vehicle includes a first component defining a storage area, a second component defining a lid that covers the storage area, a first plate attached to the first component, the first plate having a portion that deflects when a force is applied to the portion, and a second plate attached to the second component and pivotally attached to the first plate, the second plate having an extension that selectively engages with the portion of the first plate. The second plate has a first position when the extension of the second plate is not engaged with the portion of the first plate, and wherein the second plate has a second position when the extension of the second plate is engaged with the portion of the first plate.

In another aspect of the present disclosure, when the second plate is in the first position, the lid covers the storage area, and wherein when the second plate is in the second position, the lid is held open by the engagement of the extension of the second plate with the portion of the first plate to provide access to the storage area.

In another aspect of the present disclosure, the storage compartment configured for placement in a bed of a truck.

In another aspect of the present disclosure, the compartment is configured for location in a cabin of the motor vehicle.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of a storage compartment according to an exemplary embodiment;

FIG. 2 is a perspective view of a hinge for the storage compartment according to an exemplary embodiment;

FIG. 3A is a perspective view of the hinge in an open position according to an exemplary embodiment;

FIG. 3B is a perspective view of the hinge in a closed position according to an exemplary embodiment;

FIG. 4A is a perspective view of a portion of the hinge in the open position according to an exemplary embodiment;

FIG. 4B is a perspective view of the portion of the hinge in the closed position according to an exemplary embodiment; and

FIG. 5 is a perspective view of a bottom plate of the hinge according to an exemplary embodiment.

### DETAILED DESCRIPTION

The following description is merely exemplary in nature and is not intended to limit the present disclosure, application, or uses.

Referring to FIG. 1, there is shown a storage compartment 10 for a motor vehicle. As shown, the storage compartment 10 is suitable for placement in a bed of a pickup truck. The storage compartment 10 includes a lid 14 and a component 16 that defines a storage area 18. The lid 14 is attached to the storage area component 16 with a set of hinges 12. For example, each hinge 12 is attached to the lid 14 and the storage area component 16 with a set of screws 20 or any other suitable attachment mechanisms. In other arrangements, the hinge 12 is molded into the storage area compartment 16 and/or the lid 14. In particular arrangements, the hinge 12 is imbedded into the storage area compartment 16 and/or the lid. Although the storage compartment 10 is typically placed in the bed of a pickup truck, the hinges 12, in various arrangements, are utilized for interior storage compartments in the cabin of the motor vehicle or any other type of compartment with a lid.

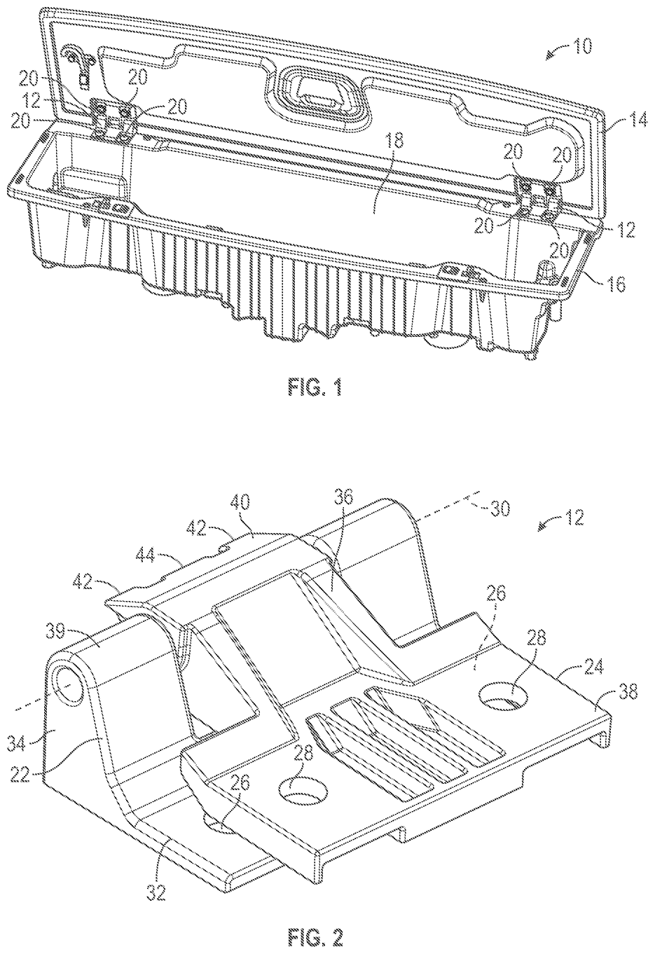

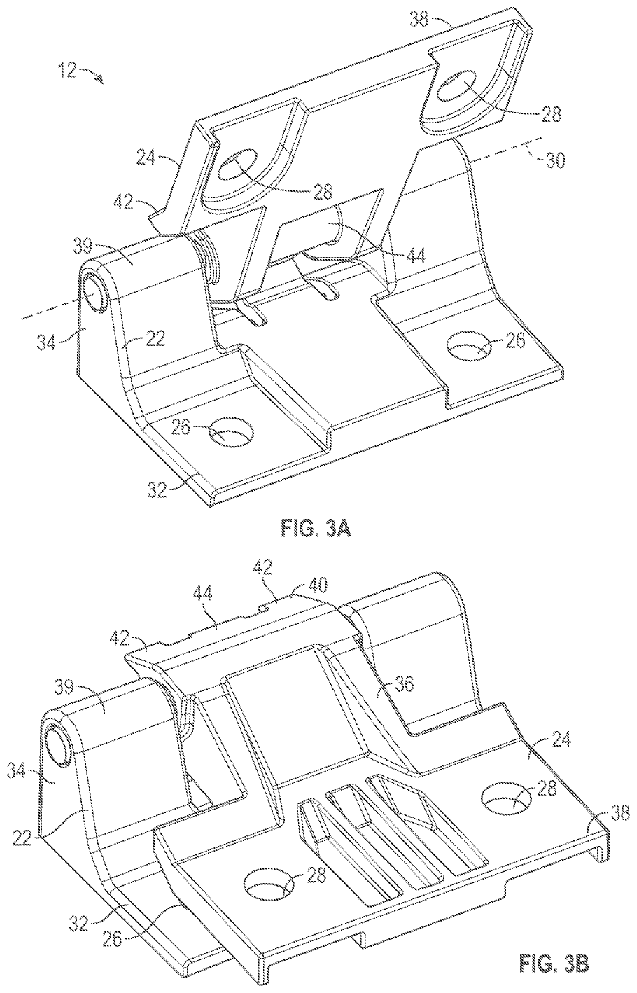

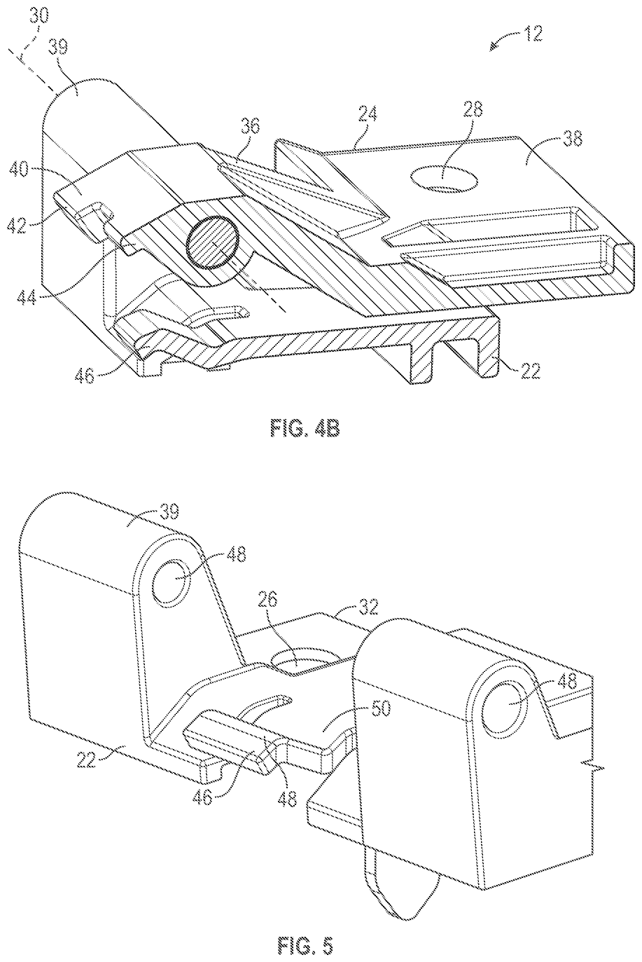

Referring to FIGS. 2, 3A and 3B, the hinge 12 includes a first plate 22 and a second plate 24. The first plate 22 includes a generally flat portion 32 and a raised portion 34. The flat portion 32 includes a set of holes 26 through which a pair of screws 20 extend to secure the first plate 22 to the component 16. The raised portion 34 includes an opening 48 (FIG. 5) through which a rod 39 extends along an axis 30. The rod 39 also extends through the second plate 24 to enable the second plate 24 to pivot about the axis 30 from an open position (FIG. 3A) to a closed position (FIG. 3B). The hinge 12 is made from metal, plastic or composite materials in various arrangements.

The second plate 24 includes a generally flat portion 38 with a set of holes 28 through which a pair of screws 20 extend to secure the second plate 24 to the lid 14. The second plate further includes a portion 36 and a portion 40 that is integral with the portion 36. The portion 40 includes a pair of extensions 42 and another extension 44.

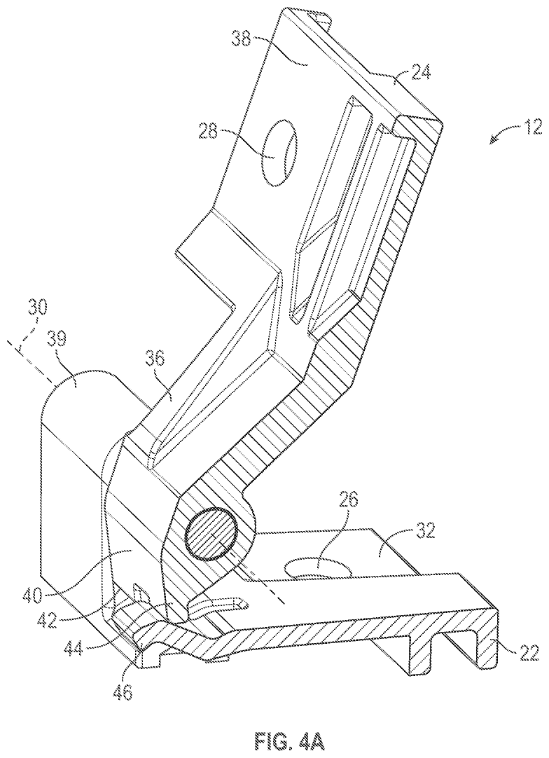

Referring further to FIG. 5, the first plate 22 also includes a cantilever portion 50 with an upward ramp 48 and a downward ramp 46. The extensions 42 of the second plate 24 reside on either side of the ramps 46 and 48. That is, the extensions 42 do not engage with the cantilever portion 50 when opening and closing the lid 14. The extension 44, however, engages with the cantilever portion 50 when the second plate 24 is in the open position as shown in FIG. 4A and is unengaged with the cantilever portion 50 when the second plate 24 is in the closed position.

More specifically, as a user lifts the lid 14 to gain access to the storage area 18, the flat portion 38 of the second plate 24 pivots away from the first plate 22. As this occurs, the extension 44 slides over the downward ramp 46, which causes the portion 50 to deflect away from the extension 44. The extension 44 then moves over the upward ramp 48 such that the portion 50 deflects towards the extension 44. As such, the extension 44 is engaged with the portion 50 when the second plate 24 is in the open position to hold the lid 14 in the open position. Accordingly, the user is able to let go of the lid 14 without the lid 14 swinging back down to the closed position.

To close the lid 14, the user pulls the lid 14 towards the component 16 with storage area 18 such that the flat portion 38 of the second plate 24 pivots towards the first plate 22. As this occurs, the extension 44 slides over the upward ramp 48, which causes the portion 50 to deflect away from the extension 44. The extension 44 then moves over the downward ramp 46 such that the portion 50 deflects towards the extension 44 as the extension 44 disengages with the portion 50. As such, the extension 44 is unengaged with the portion 50 when the second plate 24 is in the closed position.

Accordingly, the hinge 12 of the present disclosure offers the advantage of enabling a user of the storage compartment 10 to access the storage area 18 without having to hold the lid 14 in the open position.

In various arrangements, the hinge 12 is a torque hinge while in other arrangements, the hinge 12 is a no torque hinge. In certain arrangements, the portion 50 of the first plate 22 and the extension 44 of the second plate 44 are configured to hold the second plate, and hence the lid 14, open at various angles.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A hinge for a compartment in a motor vehicle, the hinge comprising:
a first plate having a portion that deflects when a force is applied to the portion; and
a second plate pivotally attached to the first plate, the second plate having an extension that selectively engages with the portion of the first plate,
wherein the second plate has a first position when the extension of the second plate is not engaged with the portion of the first plate, and wherein the second plate has a second position when the extension of the second plate is engaged with the portion of the first plate.

2. The hinge of claim 1, wherein the first plate is attached to a first component of the compartment, the first component defining storage area.

3. The hinge of claim 2, wherein the second plate is attached to a second component of the compartment, the second component being a lid.

4. The hinge of claim 3, wherein when the second plate is in the first position, the lid covers the storage area.

5. The hinge of claim 4, wherein when the second plate is in the second position, the lid is held open by the engagement of the extension of the second plate with the portion of the first plate to provide access to the storage area.

6. The hinge of claim 1, wherein the first plate and the second plate are made of a metal.

7. The hinge of claim 1, wherein the first plate and the second plate are made of a plastic.

8. The hinge of claim 1, wherein the first plate and the second plate are made of a composite material.

9. The hinge of claim 1, wherein the compartment is a storage compartment located in a bed of a truck.

10. The hinge of claim 1, wherein the compartment is located in a cabin of the motor vehicle.

11. A hinge for a compartment in a motor vehicle, the hinge comprising:
a first plate having a portion that deflects when a force is applied to the portion, the first plate being attached to a first component of the compartment, the first component defining storage area; and
a second plate pivotally attached to the first plate, the second plate having an extension that selectively engages with the portion of the first plate, the second plate being attached to a second component of the compartment, the second component being a lid,
wherein the second plate has a first position when the extension of the second plate is not engaged with the portion of the first plate, and wherein the second plate has a second position when the extension of the second plate is engaged with the portion of the first plate.

12. The hinge of claim 11, wherein when the second plate is in the first position, the lid covers the storage area.

13. The hinge of claim 14, wherein when the second plate is in the second position, the lid is held open by the engagement of the extension of the second plate with the portion of the first plate to provide access to the storage area.

14. The hinge of claim 11, wherein the first plate and the second plate are made of a metal.

15. The hinge of claim 11, wherein the first plate and the second plate are made of a plastic.

16. The hinge of claim 11, wherein the first plate and the second plate are made of a composite material.

17. A storage compartment for a motor vehicle, the storage compartment comprising:
a first component defining a storage area;
a second component defining a lid that covers the storage area;
a first plate attached to the first component, the first plate having a portion that deflects when a force is applied to the portion; and
a second plate attached to the second component and pivotally attached to the first plate, the second plate having an extension that selectively engages with the portion of the first plate,
wherein the second plate has a first position when the extension of the second plate is not engaged with the portion of the first plate, and wherein the second plate has a second position when the extension of the second plate is engaged with the portion of the first plate.

18. The storage compartment of claim 17, wherein when the second plate is in the first position, the lid covers the storage area, and wherein when the second plate is in the second position, the lid is held open by the engagement of the extension of the second plate with the portion of the first plate to provide access to the storage area.

19. The storage compartment of claim 17, wherein the storage compartment configured for placement in a bed of a truck.

20. The storage compartment of claim 17, wherein the compartment is configured for location in a cabin of the motor vehicle.
